(19) United States
(12) Patent Application Publication
(10) Pub. No.: US 2016/0011359 A1
(43) Pub. Date: Jan. 14, 2016

(54) REFLECTIVE DISPLAY FOR PREVENTING COLOR DISTORTION AND DETERIORATION OF COLOR PURITY

(71) Applicant: E Ink Holdings Inc., HSINCHU (TW)

(72) Inventors: I-Jeng CHEN, HSINCHU (TW); Yu-Nan PAO, HSINCHU (TW); Hsin-Tao HUANG, HSINCHU (TW); Yu-Nan TSAO, HSINCHU (TW)

(21) Appl. No.: 14/864,842

(22) Filed: Sep. 24, 2015

Related U.S. Application Data
(63) Continuation of application No. 13/610,902, filed on Sep. 12, 2012.
(60) Provisional application No. 61/568,168, filed on Dec. 8, 2011.

(30) Foreign Application Priority Data
May 11, 2012 (TW) 101116903

(51) Int. Cl. F21V 8/00

(52) U.S. Cl. CPC G02B 6/0036; G02B 6/0038; G02B 6/0043

(57) ABSTRACT

A reflective display includes a display panel, a first color filter layer, a second color filter layer, a light guide plate, and a light source. The first color filter layer is disposed on the display panel; the second color filter layer is disposed on the display panel and arranged with the first color filter layer in parallel. The light source is disposed beside the side surface of the light guide plate and is capable of emitting light, in which and the light is reflected by the internal side of the first surface of the light guide plate, such that the light enters the first color filter layer, and the light is reflected by the display panel and emitted from the first color filter layer, in which optical path of the light passes through the first color filter layer and does not pass through the second color filter layer.

### RELATED APPLICATIONS

This application is a Continuation Application of the application Ser. No. 13/610,902, filed Sep. 12, 2012, which claims priority to U.S. Provisional Application Ser. No. 61/568,168, filed Dec. 8, 2011, and Taiwanese Application serial number 101116903, filed May 11, 2012, the disclosures of which are incorporated herein by reference in their entireties.

### BACKGROUND

1. Field of Invention

The present invention relates to a display. More particularly, the present invention relates to a reflective display.

2. Description of Related Art

The liquid crystal display which exhibit high quality image with small power is widely employed in various kinds of electronics. A liquid display device is generally classified into the ones of a penetration type and a reflection type. Generally speaking, the reflection type display device includes a reflection layer which reflects the incident light coming from outside the device as the light source for displaying images.

In the conventional reflection type display, the deposition of the light guide plate makes the light pass through various colors of the color filter layers, so as to deteriorate the color quality and purity of the color of the display device.

In this regard, the conventional reflection type display still has defects and needs to be improved. To solve the above mentioned problem, different solutions from related field have been searched and the results are not satisfactory. Therefore, how to prevent the light from passing through the color filter layer of different colors is important and essential to avoid color distortion and the deterioration of the color purity thereof.

### SUMMARY

According to one embodiment of the present invention, a reflective display includes a display panel, a first color filter layer, a second color filter layer, a light guide plate, and a light source. The first color filter layer is disposed on the display panel; the second color filter layer is disposed on the display panel and arranged with the first color filter layer in parallel. The light guide plate includes a first surface, a second surface, and a side surface. The second surface is disposed opposite to the first surface, in which the light guide plate is disposed on the first color filter layer and the second color filter layer. The side surface is connected between the first surface and the second surface, and the light source is disposed beside the side surface of the light guide plate and is capable of emitting light, in which the light is reflected by the internal side of the first surface of the light guide plate after entering the side surface of the light guide plate, such that the light enters the first color filter layer, and the light is reflected by the display panel and emitted from the first color filter layer, in which optical path of the light passes through the first color filter layer and does not pass through the second color filter layer.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a structure diagram of reflective display according to one embodiment of the present invention;

FIG. 2 is a disposition diagram of a color filter layer and a light source according to one embodiment of the present invention;

FIG. 3 is a structure diagram of a reflective display according to the other embodiment of the present invention; and

FIG. 4 is a disposition diagram of a color filter layer and a light source according to the other embodiment of the present invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

The drawings are illustrative and do not present the real size of the present invention; in addition, the well known elements and steps are not recited in the embodiments for unnecessarily limiting the present invention.

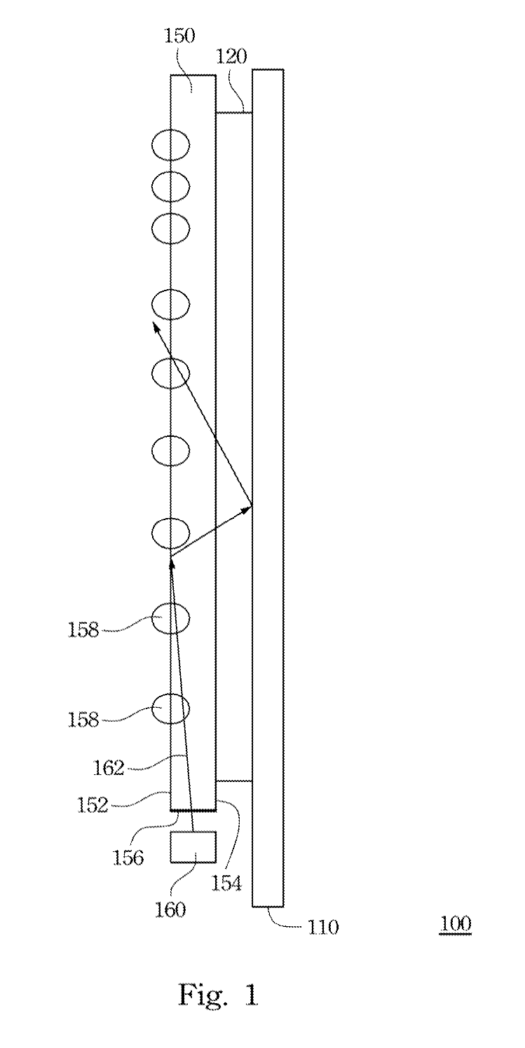

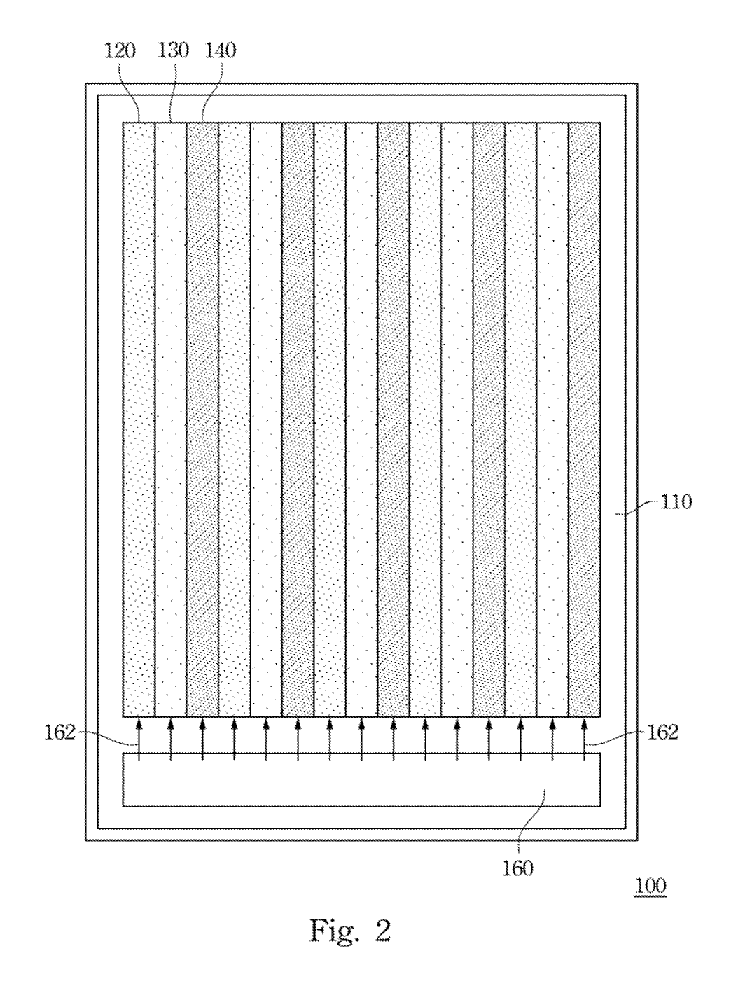

FIG. 1 is a structure diagram of reflective display according to one embodiment of the present invention, and FIG. 2 is a disposition diagram of a color filter layer and a light source according to one embodiment of the present invention. The reflective display 100 includes a display panel 110, a first color filter layer 120, a second color filter layer 130, a light guide plate 150, and a light source 160. The display panel 110 can be a liquid crystal display or a Electro-Phoretic Display (EPD). In the structure, the first color filter layer 120 and the second color filter layer 130 are disposed on the display panel 110. The second color filter layer 130 is arranged with the first color filter layer in parallel. For example, the first color filter layer 120 can be a red color filter layer, and the second color filter layer 130 can be a green color filter layer. addition, the reflective display 100 can further includes a third color filter 140, such as a blue color filter layer. However, these color filter layers are illustrative and should not be used for limiting the scope of the present invention.

Furthermore, the light guide plate 150 includes a first surface 152, a second surface 154, and a side surface 156. The second surface 154 is disposed opposite to the first surface 152, in which the light guide plate 150 is disposed on the first color filter layer 120 and the second color filter layer 130, and the second surface 154 of the light guide plate 150 is adjacent to the first color filter layer 120 and the second color filter layer 130. In addition, the side surface 156 is connected to the first surface 152 and the second surface 154, and the light source 160 is disposed beside the side surface 156 of the light guide plate 150.

As shown in FIG. 1, the light 162 emitted by the light source 160 is reflected by the internal side of the first surface 152 of the light guide plate 150 after entering the side surface 156 of the light guide plate 150, such that the light 162 enters the first color filter layer 120 and reflected by the display panel 110 and emitted from the first color filter layer 120. The light 162 proceeds and passes the light guide plate 150 which enables the user to view the images displayed by the reflective display 100.

As shown in FIG. 1 and FIG. 2, another light substantially parallel to the light 162 after entering the side surface 156 of the light guide plate 150 is reflected by the internal of the first surface 152 of the light guide plate 150, such that another light can pass the second color filter layer 130 and be reflected by the display panel 150, which enables the user to view the images displayed by the reflective display 100.

FIG. 2 is a disposition diagram of a color filter layer and a light source according to one embodiment of the present invention. With the element disposition of the reflective display 100 of the embodiment of the present invention, the optical path of one of the light passes through the first color filter layer 120 and does not pass through the second color filter layer 130; or the optical path of the light passes through the second color filter layer 130 and does not pass through the first color filter layer 120. That is, after entering the light guide plate 150, the light merely passes a single color filter layer, which prevents the color distortion and the deterioration of color purity due to the light passing through the color filter layers of different colors, and the color displaying quality of the reflective display is thus maintained.

As shown in FIG. 1, the first surface 152 of the light guide plate 150 includes plenty of microstructures 158 distributed on the first surface 152, and the light 162 is reflected by the microstructures 158 distributed on the internal side of the first surface 152 of the light guide plate 150 after the light enters the side surface 156 of the light guide plate 150. The microstructures 158 are arranged more closely along a direction away from the light source 160.

As stated above, each of the microstructures 158 can be a dot-shaped structure. After entering the side surface 156 of the light guide plate 150, the light 162 is reflected and refracted by the dot-shaped structures 158 distributed on the internal side of the first surface 152 of the light guide plate 150. In addition, the light source 160 can be a strip-shaped light source, and the first color filter layer 120 and the second color filter layer 130 are strip-shaped filter layers, in which the direction of the longitudinal side of the light source 160 is substantially perpendicular to the direction of the longitudinal sides of the first color filter layer 120 and the second color filter layer 130.

Particularly, the direction of the longitudinal side of the light source 160 is substantially perpendicular to the direction of the longitudinal sides of the first color filter layer 120 and the second color filter layer 130. For example, the included angle between the direction of the longitudinal side of the light source 160 and the longitudinal sides of the first color filter layer 120 ranges from 80 degree to 100 degree.

The light guide plate 150 can be implemented with a non-collimated light guide plate, such as implemented with a dot structure light guide plate. However, it should not be used for limiting the present invention, and person skilled in the art can still choose light guide plate having microstructures of different shapes according to the demands.

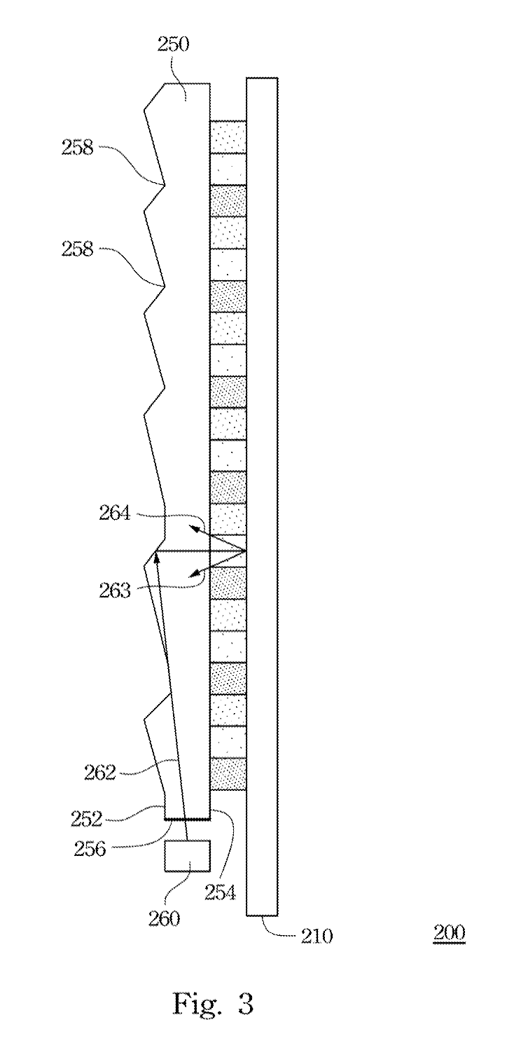

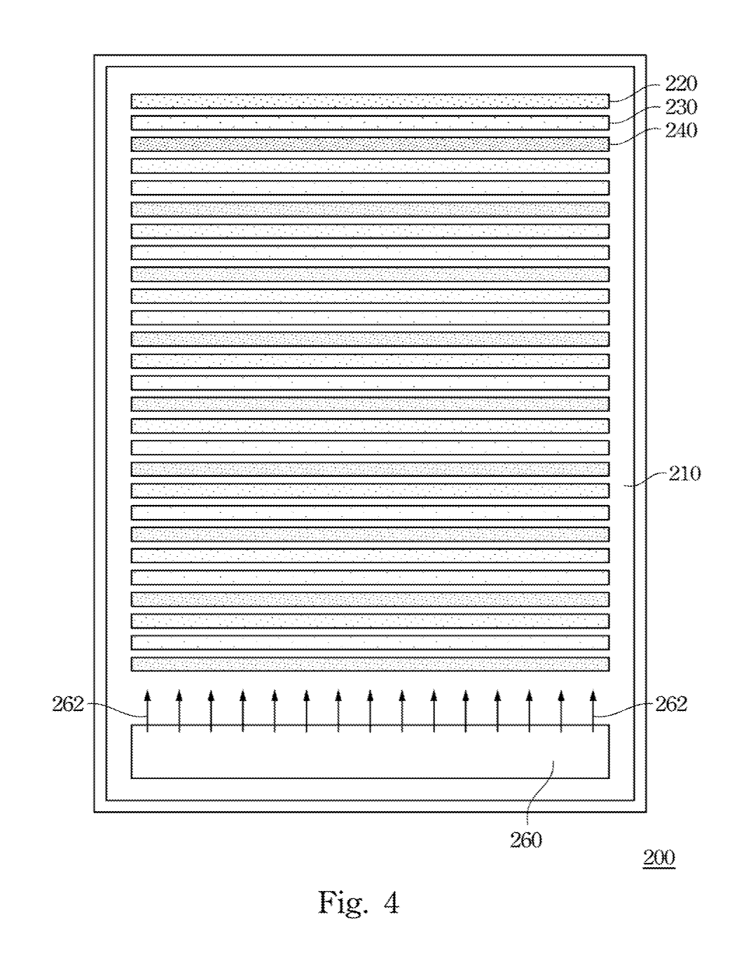

FIG. 3 is a structure diagram of a reflective display according to the other embodiment of the present invention, and FIG. 4 is a disposition diagram of a color filter layer and a light source according to the other embodiment of the present invention, The reflective display 200 includes a display panel 210, a first color filter layer 220, a second color filter layer 230, a light guide plate 250, and a light source 260. The display panel 110 can be a liquid crystal display or a Electro-Phoretic Display (EPD). Specifically, the first color filter layer 220 can be a red color filter layer, and the second color filter layer 230 can be a green color filter layer. In addition, the reflective display 200 can further includes a third color filter 240, such as a blue color filter layer. However, these color filter layers are illustrative and should not be used for limiting the scope of the present invention. The structures of the internal elements disposing of the reflective display 200 and the reflective display 100 shown in FIG. 1 are the same.

Furthermore, the light guide plate 250 includes a first surface 252, a second surface 254, and a side surface 256. The structure and the disposing of the light guide plate 250 are almost the same with those of the light guide plate 150, however, there are still some differences between them. Unlike the light guide plate 150, the microstructures 258 of the light guide plate 250 are V cut grooves disposed in parallel with each other.

As shown in FIG. 3, the light 262 is reflected by the V cut grooves distributed on the internal side of the first surface 252 of the light guide plate 250 after entering the side surface 256 of the light guide plate 250, such that the light 262 can enter the first color filter layer 220 or the second color filter layer 230 with substantially perpendicular direction, that is, the reflective display 200 can emit the collimated light to the display panel 210 through the V cut grooves. After the light 262 is reflected by the display panel 210, the reflected light 263, 264 will produce a dispersed angle and will pass only one single color filter layer

As the element disposing of the reflective display 200 shown in FIG. 3 and FIG. 4, the optical path of one of the light 262 passes through the first color filter layer 220 and does not pass through the second color filter layer 230; or the optical path of the light 262 passes through the second color filter layer and does not pass through the first color filter layer. That is, after entering the light guide plate 250, within the reflective structure 200, the light merely passes a single color filter layer, which prevents the color distortion and the color purity decreasing due to the light passing through several color filter layers of different colors, and the color displaying quality of the reflective display 200 is thus maintained.

In this embodiment, the light source 260 is a strip-shaped light source, and the first color filter layer 220 and the second color filter layer 230 are strip-shaped filter layers, in which the direction of the longitudinal side of the light source 260 is substantially perpendicular to the direction of the longitudinal sides of the first color filter layer 220 and the second color filter layer 230, further substantially parallel to the V cut grooves.

The light guide plate 250 can be implemented with a collimated light guide plate, such as implemented with a v-cut cannelure light guide plate. However, it should not be used for limiting the present invention, and person skilled in the art can still choose light guide plate having microstructures of different shapes according to the demands.

In another embodiment, each of the microstructure 258 is a pyramid-shaped structure formed with two v cut grooves vertical to each other, and the light 262 the is reflected by the pyramid-shaped structures distributed on the internal side of the first surface 252 of the light guide plate 250 after entering the side surface 256 of the light guide plate 250. The cross-sectional view of the pyramid-shaped structure is shown in FIG. 3.

Compared with the V cut grooves, the pyramid-shaped structure includes four incline surfaces. By changing the angle of the output light through altering the angle of the above mentioned incline surfaces, the scattered light can be converged, such that the resolution of the reflective display can be improved. The reflective display 200 can output collimated light to the display panel 210 through the pyramid-shaped structure. When the light 262 is reflected by the display panel 210, the reflected lights 263, 264 form a scattered angle. The reflected lights 263, 264 basically pass through only one single color filter layer.

As shown in FIG. 4, the light source 260 is a strip-shaped light source if the microstructures 258 are pyramid-shaped structures, and the first color filter layer 220 and the second color filter layer 230 are strip-shaped filter layers, in which the direction of the longitudinal side of the light source 260 is substantially perpendicular to the direction of the longitudinal sides of the first color filter layer 220 and the second color filter layer 230.

As shown in FIG. 2, the light source 160 is a strip-shaped light source if the microstructures 158 are pyramid-shaped structures, and the first color filter layer 120 and the second color filter layer 130 are strip-shaped filter layers, in which the direction of the longitudinal side of the light source 160 is substantially perpendicular to the direction of the longitudinal sides of the first color filter layer 120 and the second color filter layer 130.

According to the above embodiment, the light in the reflective display will not pass through color filter layers if different colors, which prevents the color distortion and the color impurity. hi addition, the employed pyramid-shaped structures having inclines for altering the light output angle, such that the scattered light can be converged and the resolution can be improved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A reflective display for preventing color distortion and deterioration of color purity, comprising:
a display panel;
a first color filter layer disposed on the display panel;
a second color filter layer disposed on the display panel;
a light guide plate, comprising;
a first surface;
a second surface disposed opposite to the first surface, wherein the light guide plate is disposed on the first color filter layer and the second color filter layer; and
a side surface connected between the first surface and the second surface; and
a light source disposed beside the side surface of the light guide plate and capable of emitting light,
wherein the first surface comprises a plurality of microstructures distributed thereon, wherein the microstructures are arranged more closely along a direction away from the light source, wherein after the light enters the side surface of the light guide plate and arrives at a first position of the first surface, the light is reflected by one of the microstructures, such that the light enters the first color filter layer, and the light is reflected by the display panel and emitted from the first color filter layer and then arrives at a second position of the first surface, wherein at least two of the microstructures are located between the first position and the second position, wherein the first position is closer to the light source than the second position is, wherein an optical path of the light passes through the first color filter layer and does not pass through the second color filter layer,
wherein the light source is a strip-shaped light source having a longitudinal axis, and the first color filter layer and the second color filter layer are strip-shaped filter layers, wherein the first color filter layer and the second color filter layer are arranged side-by-side and parallel to each other, wherein the side-by-side arrangement of the first and second color filter layers is along a direction that is parallel to the longitudinal axis of the light source.

2. The reflective display according to claim 1, wherein after the light enters the side surface of the light guide plate, the light is reflected by an internal side of the first surface of the light guide plate, such that after the light enters the second color filter layer and is reflected by the display panel, the light is emitted from the second color filter layer, wherein the optical path of the light passes through the second color filter layer and does not pass through the first color filter layer.

3. The reflective display according to claim 1, wherein each of the microstructures is a dot-shaped structure, and the light is reflected and refracted by the dot-shaped structures distributed on an internal side of the first surface of the light guide plate after the light enters the side surface of the light guide plate.

4. The reflective display according to claim 3, wherein the direction of the longitudinal axis of the light source is substantially perpendicular to a direction of longitudinal sides of the first color filter layer and the second color filter layer.

5. The reflective display according to claim 1, wherein the microstructures are V cut grooves disposed in parallel with each other, and the light is reflected by the V cut grooves distributed on an internal side of the first surface of the light guide plate after the light enters the side surface of the light guide plate.

6. The reflective display according to claim 1, wherein each of the microstructures is a pyramid-shaped structure, and the light is reflected by the pyramid-shaped structures distributed on an internal side of the first surface of the light guide plate after the light enters the side surface of the light guide plate.

7. The reflective display according to claim 6, wherein the direction of the longitudinal axis of the light source is substantially perpendicular to a direction of longitudinal sides of the first color filter layer and the second color filter layer.

8. The reflective display according to claim 1, wherein the first color filter layer and the second color filter layer have different colors, and the light guide plate is a front light mounted to a front side of the display panel.
